(19) United States
(12) Patent Application Publication
(10) Pub. No.: US 2013/0346196 A1
(43) Pub. Date: Dec. 26, 2013

(54) LIFE CYCLE MILESTONE SUGGESTION

(71) Applicant: Ivy Ho, Thornhill (CA)

(72) Inventor: Ivy Ho, Thornhill (CA)

(73) Assignee: INTERNATIONAL BUSINESS MACHINES CORPORATION, Armonk, NY (US)

(21) Appl. No.: 13/527,717

(22) Filed: Jun. 20, 2012

(51) Int. Cl. G06Q 30/02

(52) U.S. Cl. 705/14.53

(57) ABSTRACT

Embodiments of the invention relate to lifecycle milestone suggestion. An aspect of the invention includes identifying a resource related to a user. A start date an end date for the resource is determined. A suggestion for at least one piece of web content is provided based on a current milestone for the resource. The current milestone is updated, and suggestions are provided based on the updated current milestone over an entire lifecycle of the resource.

### BACKGROUND

This invention relates generally to processing within a computing environment, and more particularly to lifestyle milestone suggestion.

The traditional model of delivering advertisements to users browsing a website is to use search keywords. More intelligent contextual targeting mechanisms also exist. If, for example, a search is performed for “Travel to China,” then the words “Travel” and “China” are registered against an index of relevant ads. These may include travel agency advertisements, or even Chinese language learning advertisements. Advertisements based on contextual targeting are only relevant during a short time frame (i.e., before a person goes on a trip to China). Therefore, contextual targeting is of limited utility.

### SUMMARY

Embodiments include a method, system, and computer program product for lifecycle milestone suggestion. An aspect of the invention includes identifying a resource related to a user. A start date an end date for the resource is determined. A suggestion for at least one piece of web content is provided based on a current milestone for the resource. The current milestone is updated, and suggestions are provided based on the updated current milestone over an entire lifecycle of the resource.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a schematic diagram of a smart web service for lifecycle milestone suggestion that may be implemented by an embodiment;

FIG. 2 depicts a schematic diagram of an example computer system for a smart web service for lifecycle milestone suggestion in an embodiment;

FIG. 3 depicts a process flow that may be implemented by an embodiment of a smart service for lifecycle milestone suggestion;

FIG. 4 depicts a process flow that may be used to identify and classify a resource and its milestones in an embodiment;

FIG. 5 depicts a process flow that may be used to monitor resources and their milestones over a lifecycle in an embodiment; and

FIG. 6 depicts a process flow that may be used to suggest web content based on a resource and milestone in an embodiment.

### DETAILED DESCRIPTION

An embodiment of the present invention provides for lifecycle milestone suggestion.

In an embodiment, a lifestyle event or resource with a starting timeframe is received. Using the starting timeframe, and an ending timeframe, lifecycle stages are determined, and the event is tracked and updated throughout the lifecycle of the event. The end timeframe of the event may be received with the starting timeframe, or may be determined based on information about the event. Furthermore, and ending timeframe may be determined at a later time based on another event.

In an embodiment, a smart web service links a resource to a timeline. Based on the specific resource one or more milestones are determined. These milestones may be time or event based, and reflect a change in state of the resource.

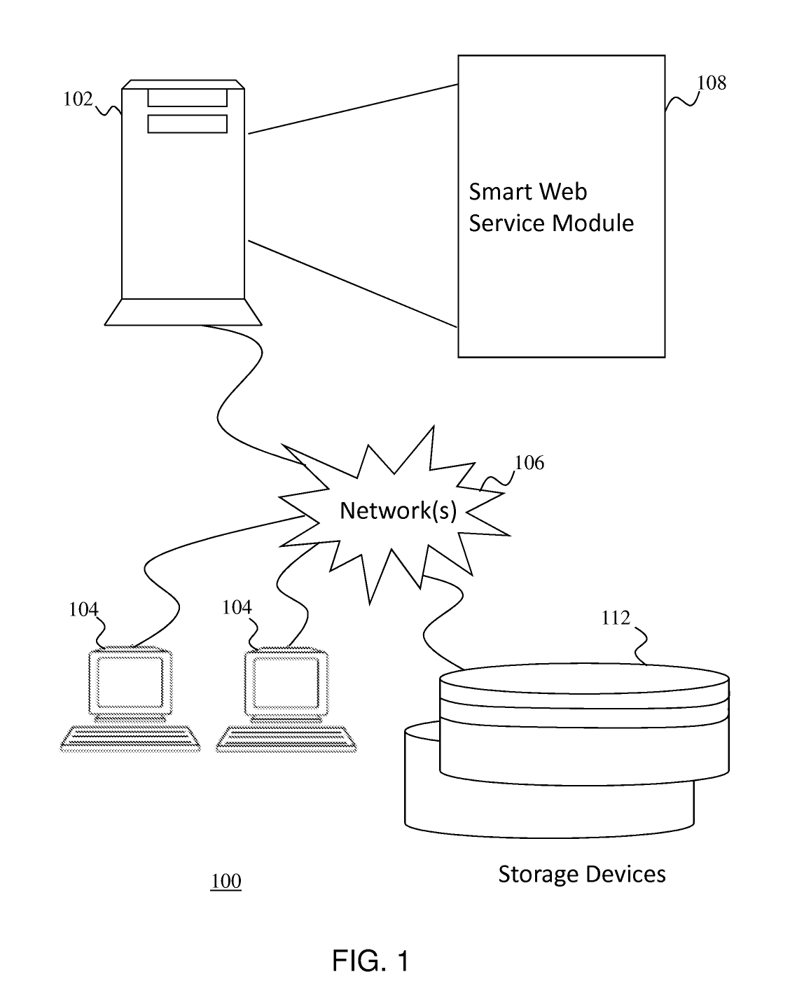

Turning now to FIG. 1, a system 100 for implementing a smart web service for lifecycle milestone suggestion will now be described. In an embodiment, the system 100 includes a host system computer 102 executing computer instructions for executing a smart web service. Host system computer 102 may operate in any type of environment that is capable of executing a software application. Host system computer 102 may comprise a high-speed computer processing device, such as a mainframe computer, to manage the volume of operations governed by an entity for which the smart web service for lifecycle milestone suggestion is executing. In an embodiment, the host system computer 102 is part of an enterprise (e.g., a commercial business) that implements the smart web service for lifecycle milestone suggestion.

In an embodiment, the system 100 depicted in FIG. 1 includes one or more client systems 104 through which users at one or more geographic locations may contact the host system computer 102. The client systems 104 are coupled to the host system computer 102 via one or more networks 106. Each client system 104 may be implemented using a general-purpose computer executing a computer program for carrying out the processes described herein. The client systems 104 may be personal computers (e.g., a lap top, a personal digital assistant, a mobile device) or host attached terminals. If the client systems 104 are personal computers, the processing described herein may be shared by a client system 104 and the host system computer 102 (e.g., by providing an applet to the client system 104). Client systems 104 may be operated by authorized users (e.g., programmers) of the smart web service for lifecycle milestone suggestion described herein.

The networks 106 may be any type of known network including, but not limited to, a wide area network (WAN), a local area network (LAN), a global network (e.g., Internet), a virtual private network (VPN), and an intranet. The networks 106 may be implemented using a wireless network or any kind of physical network implementation known in the art. A client system 104 may be coupled to the host system computer 102 through multiple networks (e.g., intranet and Internet) so that not all client systems 104 are coupled to the host system computer 102 through the same network. One or more of the client systems 104 and the host system computer 102 may be connected to the networks 106 in a wireless fashion. In one embodiment, the networks 106 include an intranet and one or more client systems 104 executing a user interface application (e.g., a web browser) to contact the host system computer 102 through the networks 106. In another embodiment, the client system 104 is connected directly (i.e., not through the networks 106) to the host system computer 102 and the host system computer 102 contains memory for storing data in support of smart web service for lifecycle milestone suggestion. Alternatively, a separate storage device (e.g., storage device 112) may be implemented for this purpose.

In an embodiment, the storage device 112 includes a data repository with data relating to smart web service for lifecycle milestone suggestion by the system 100, as well as other data/information desired by the entity representing the host system computer 102 of FIG. 1. The storage device 112 is logically addressable as a consolidated data source across a distributed environment that includes networks 106. Information stored in the storage device 112 may be retrieved and manipulated via the host system computer 102 and/or the client systems 104. In an embodiment, the storage device 112 includes one or more databases containing, e.g., smart web service for lifecycle milestone suggestion and corresponding configuration parameters, values, methods, and properties, as well as other related information as will be discussed more fully below. It will be understood by those of ordinary skill in the art that the storage device 112 may also comprise other structures, such as an XML file on the file system or distributed over a network (e.g., one of networks 106), or from a data stream from another server located on a network 106. In addition, all or a portion of the storage device 112 may alternatively be located on a client system 104.

The host system computer 102 depicted in the system of FIG. 1 may be implemented using one or more servers operating in response to a computer program stored in a storage medium accessible by the server. The host system computer 102 may operate as a network server (e.g., a web server) to communicate with the client systems 104. The host system computer 102 handles sending and receiving information to and from the client systems 104 and can perform associated tasks. The host system computer 102 may also include a firewall to prevent unauthorized access to the host system computer 102 and enforce any limitations on authorized access. For instance, an administrator may have access to the entire system and have authority to modify portions of the system. A firewall may be implemented using conventional hardware and/or software as is known in the art.

The host system computer 102 may also operate as an application server. The host system computer 102 executes one or more computer programs to provide the smart web service for lifecycle milestone suggestion. The host system computer 102 includes a smart web service module 108. As indicated above, processing may be shared by the client systems 104 and the host system computer 102 by providing an application (e.g., java applet) to the client systems 104. Alternatively, the client system 104 can include a stand-alone software application for performing a portion or all of the processing described herein. As previously described, it is understood that separate servers may be utilized to implement the network server functions and the application server functions. Alternatively, the network server, the firewall, and the application server may be implemented by a single server executing computer programs to perform the requisite functions.

It will be understood that the generation of the smart web service for lifecycle milestone suggestion described in FIG. 1 may be implemented in hardware, software executing on a general purpose computer, or a combination thereof.

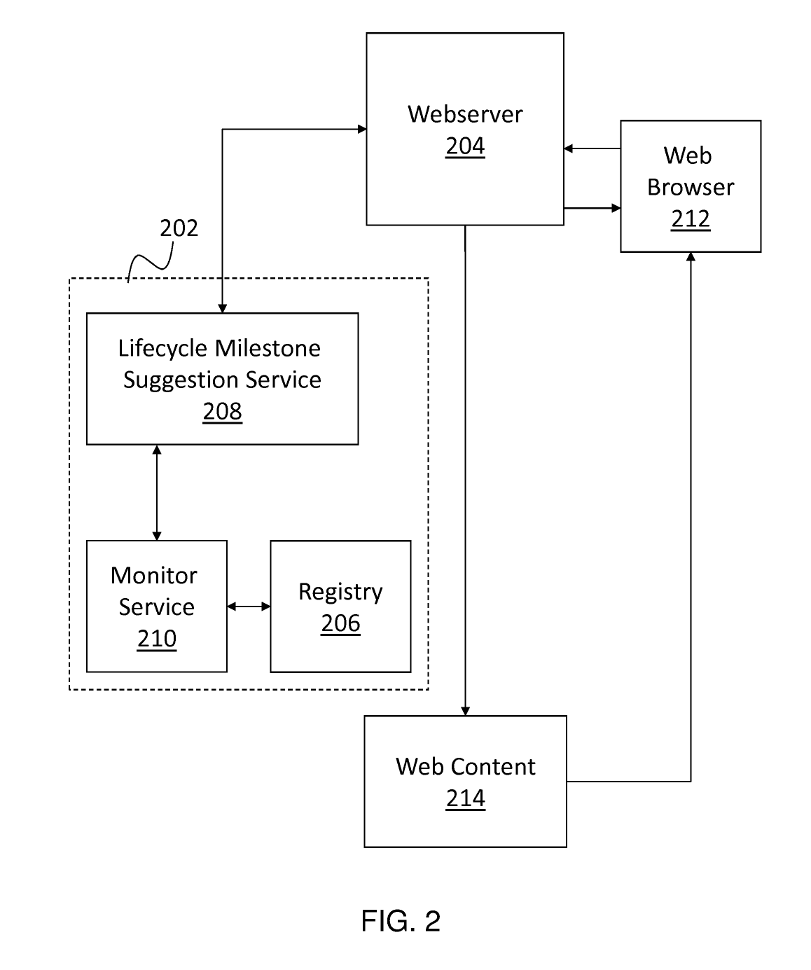

FIG. 2 depicts a schematic diagram of an example computer system 100 for a smart web service for lifecycle milestone suggestion in an embodiment. In an embodiment, a smart web service module 202 includes a monitor service 210. The monitor service 210 monitors data collected from various sources and uses that data to learn about various users of the service and to determine and model lifecycles of resources associated with each of the users. The monitor service 210 collects information based on user interaction with the Internet. In an embodiment, the monitor service 210 collects information from web searches, social networking sites, data feeds collected from third parties, public registries, or any other source of user information such as purchase histories, etc. In an embodiment, the monitor service 210 collects information by crawling the Internet for data related to known resources using, for example, a web crawler. Once the monitor service 210 determines a resource and models the milestone, the information is stored in the registry 206 where it may be later accessed, updated and/or modified.

The smart web service module 202 additionally includes a lifecycle milestone suggestion service 208. The lifecycle milestone suggestion service 208 receives requests from a webserver 204 for suggestions based on data collected from a user (not shown) interacting with the webserver 204 via a web browser 212. The lifecycle milestone suggestion service 208 receives a lifecycle model from the monitor service 210 based on the current milestone of the user interacting with the webserver 204 and provides a suggestion for web content 214 according to the current milestone. The web content 214 includes advertisements, surveys, or other sponsored or unsponsored content that may interest the user based on their current milestones.

In an embodiment, a user may have multiple concurrent resources and milestones, and therefore the suggestion for web content 214 may include multiple pieces of content. The webserver 204 may be configured to select one or more of the suggestions for web content 214, and return the selected web content 214 along with the information requested by the user.

For example, when a user searches the web for “baby names” and that user subsequently posts information and pictures about the birth of their child on a web site, the monitor service 210 will determine that a resource exists and that the resource is a baby. The monitor service 210 will store this information in the registry 206. In an embodiment, analytics are performed by the monitor service 210 on the resource in order to determine the birthdate of the baby. The birthdate may be determined from the user's profile information, or an estimate of the age of the baby based on information available to the monitor service 210. This will result in a start time for the resource. The lifecycle milestone suggestion service 208 will create suggestions for web content 214 based on the different milestone of the resource. In this example, the baby's milestones. The milestones will progress over time. For example, the baby will need different diapers in year 1. They may need different baby food, and baby toys in year 2. By year 3, they may need to go to a nursery school. Various products that are suitable for these various milestones are then suggested as each milestone occurs. The monitor service 210 continues to monitor the milestones over time. When the baby grows into a teenager, they may receive other more relevant advertisements for e.g. university information, driving lessons, motorcycle, and vehicle.

The monitoring continues until the resource reaches its end. For a baby, that could be once the child reaches adulthood. In an embodiment, the end of the resource may also trigger relevant advertisements if applicable. If the resource is a human, the end of the resource could be the death of human. At that point the suggested content may be virtual memorial web site ads, funeral arrangement, etc. In an additional embodiment, if the resource is a baby, and the baby has grown into adulthood, advertisements may be directly targeted to the “baby” rather than their parents.

In another example, a resource is a house. The start time for the resource will be when a house is purchased or moved into by the user. The end time will be when the house is sold or the user has moved out. The different milestone of the house include when the house is 10 years old, at which time a new roof may be needed.

In an embodiment, the milestones are related to the end of the useful life of the product. For example, if new furniture was purchased by a user, then a milestone may be timed to the expected time required to replace the furnace. If a face cream has been purchased by the user, the smart server may estimate the end date (i.e., the consumption) of the face cream, and suggest advertisements for different types of face cream, or prompt for a repurchase of same face cream. In addition, the user may be prompted for feedback on existing face cream when the user searches the web for similar products. In these cases, only one milestone is required for the resource.

FIG. 2 depicts several components within the smart web service module 202, however, it will be understood that in an embodiment the smart web service module 202 may include a single set of logic and may not be discrete components. Furthermore, in embodiments, the smart web service module 202 may execute on the webserver 204, or may be executed on separate, and/or dedicated hardware and be accessible via, for example, a web service call from the webserver 204.

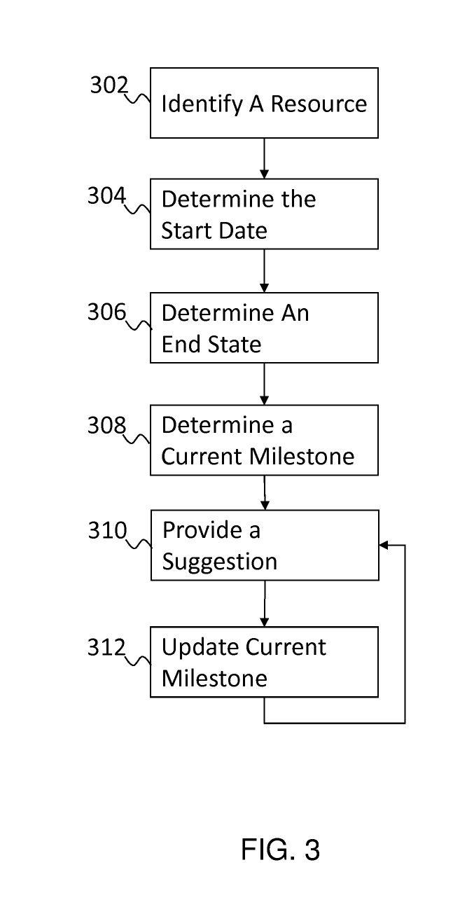

FIG. 3 depicts a process flow that may be implemented by an embodiment of a smart service for lifecycle milestone suggestion. In an embodiment, the process flow of FIG. 3 is executed by the smart web service module 202 of FIG. 2. At block 302, a resource is identified. The resource may be any object or event that has one or more milestones. Non-limiting examples of resources include, children, automobiles, appliances, homes, marriages, etc. In an embodiment, the resource is identified based on one or more search queries, information posted to one or more sites, current and previous purchases, and/or business intelligence or other data mined or received from a third party.

At block 304, a start date is determined for the resource. At block 306, an end state is determined for the resource. At block 308, a current milestone is determined for the resource. At block 310, a suggestion is provided based on the current milestone. In an embodiment the suggestion is provided in response to a request from the webserver 204 of FIG. 2. At block 312, the current milestone is updated. In an embodiment, the current milestone is updated based on elapsed time, the occurrence of an event, or a combination thereof as will be described in more detail below. Blocks 310 and 312 are executed for the entire lifecycle of the resource as will be described in more detail below.

FIG. 3 depicts a high level process flow of the various processing steps for a smart service for lifecycle milestone suggestion. Additional details for each of the steps is provided in the figures and description below.

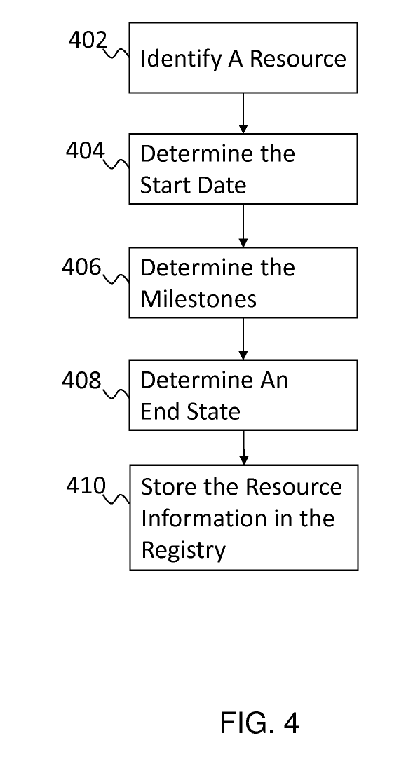

FIG. 4 depicts a process flow that may be used to identify and classify a resource and its milestones in an embodiment. In an embodiment, the process flow of FIG. 4 is executed by the smart web service module 202 of FIG. 2. At block 402, a resource is identified. The resource may be any object or event that has one or more milestones. Non-limiting examples of resources include, children, automobiles, appliances, homes, marriages, etc. In an embodiment, the resource is identified based on one or more search queries, information posted to one or more sites, current and previous purchases, and/or business intelligence or other data mined or received from a third party.

At block 404, the start date of the resource is determined. The start date of the resource is determined based on the resource itself. In an embodiment, the monitor service 210 is configured to determine the start date of the resource based on a resource classification and the available information related to the resource. For example, if the resource is classified is an appliance, the start date is the date of purchase. The date of purchase may be determined by querying the user, purchase records from where the appliance was purchased, entries on a social network, or elsewhere on the Internet. At block 406, the milestones are determined. The milestones for a resource are determined based on the resource classification, the start date, and the current date. For example, if a new appliance was purchased today, then a milestone may be an extend warranty purchase window. If the appliance was purchased 4 years ago, then the milestone may be maintenance. If the appliance was purchased 10 years ago, the milestone may be a replacement purchase.

At block 408, an end state for the resource will be identified. In an embodiment, the end state is a date after which the resource will no longer be relevant, or a transformation event wherein a resource transforms into a new resource (e.g., a child moving into adulthood). In an additional embodiment, the end state is a transition event wherein the resource transitions into a different state. For example, for a person, the end state would be death. It will be understood that these states are not mutually exclusive. For example, if the resource is a 30 year mortgage, then the end date is typically the end of the loan (30 years after the loan start), but may also be the sale of the house, or the payoff of the loan.

At block 410, the resource and all associated information (i.e., start date, end state, milestone, etc.) are stored in the registry 206.

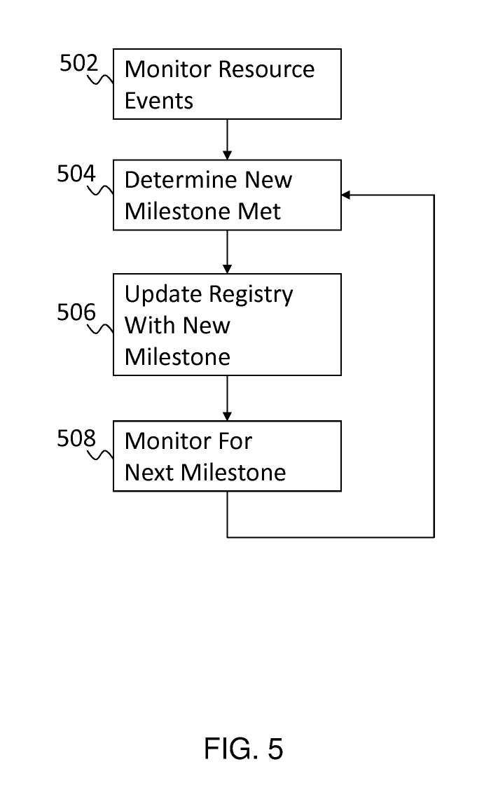

FIG. 5 depicts a process flow that may be used to monitor resources and their milestones over a lifecycle in an embodiment. In an embodiment, the process flow of FIG. 5 is executed by the smart web service module 202 of FIG. 2. At block 502, events related to the resource are monitored. The events are monitored through, for example, one or more search queries, information posted to one or more sites, current and previous purchases, and/or business intelligence or other data mined or received from a third party, etc. At block 504, as resource events are captured, it is determined if any new milestones have been crossed, or if any old milestones have expired. At block 506, if any new milestones have been discovered, or old milestones have expired, the registry 206 is updated with new milestone information. At block 508, the resource is monitored for additional events for the entirety of its lifecycle until the end state for the resources has been reached.

In an embodiment, when the end state has been reached the resource is removed from the registry 206 and monitoring for the resource is completed. In an additional embodiment, the resource is converted to a new resource based on the end state. For example, if the resource is a child, the end state is adulthood, and once the end state is reached, the resource is converted from a child to an adult. In further embodiments, the end state will trigger one or more cleanup actions, such as removing additional resources from the registry that are no longer relevant, removing email addresses for the resource, eliminating user accounts for the resource, etc. Although the process flow of FIG. 5 is directed to a single resource for clarity, it will be understood that in embodiments, all resources are monitored for events simultaneously.

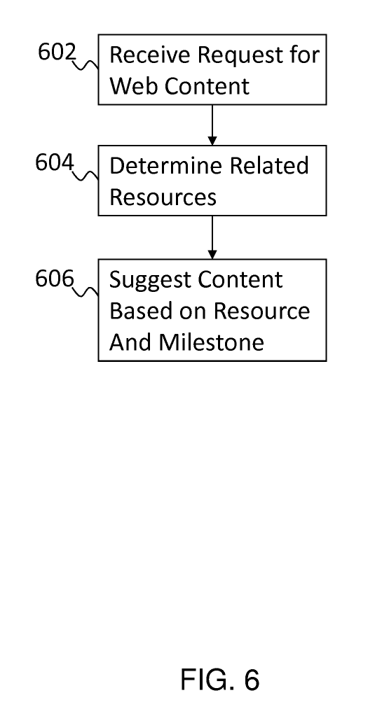

FIG. 6 depicts a process flow that may be used to suggest web content based on a resource and milestone in an embodiment. In an embodiment, the process flow of FIG. 6 is executed by the smart web service module 202 of FIG. 2. At block 602, a request is received for web content 214. In an embodiment, the request is received from a webserver 204 of FIG. 2 that has received a request for content from a web browser 212 operated by a user. At block 604, the registry 206 is searched for resources related to the request. In an embodiment, the registry 206 is searched based on content in the request and information about the user that has made the request. The information about the content request is provided by the webserver 204, or some other intermediary based on the uniform resource locator (URL) and/or form data submitted by the user. In an embodiment, the information is preprocessed by the webserver 204. In other embodiments, the smart web service module 202 receives raw data and processed the data itself. The user information is either provided by the user, or retrieved from a cookie previously stored on the user's web browser 212.

At block 606, content, such as one or more advertisements, is suggested to the webserver 204 to be displayed to the user based on one or more resources and milestones discovered by the registry 206. In an embodiment, the suggestion is provided to the webserver 204 as a URL. In an additional embodiment, the suggestion is provided to the webserver 204 as an identifier (ID) that the webserver 204 uses to find the suggested content in a content repository.

The various milestone and resource descriptions and examples are provided for clarity and are not limiting. It will be understood by those of ordinary skill in the art that other milestones, resources and examples may be used in other embodiments.

Technical effects and benefits include providing content suggestions for a resource over an entire lifecycle of the resource. An additional benefit includes shifting milestones automatically based on dates and/or events and providing content suggestions based on those shifting milestones. A further benefit includes automatically determining the end state for a resource and terminating the resource, or converting the resource to a new resource.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or schematic diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As described above, embodiments can be embodied in the form of computer-implemented processes and apparatuses for practicing those processes. In embodiments, the invention is embodied in computer program code executed by one or more network elements. Embodiments include a computer program product on a computer usable medium with computer program code logic containing instructions embodied in tangible media as an article of manufacture. Exemplary articles of manufacture for computer usable medium may include floppy diskettes, CD-ROMs, hard drives, universal serial bus (USB) flash drives, or any other computer-readable storage medium, wherein, when the computer program code logic is loaded into and executed by a computer, the computer becomes an apparatus for practicing the invention. Embodiments include computer program code logic, for example, whether stored in a storage medium, loaded into and/or executed by a computer, or transmitted over some transmission medium, such as over electrical wiring or cabling, through fiber optics, or via electromagnetic radiation, wherein, when the computer program code logic is loaded into and executed by a computer, the computer becomes an apparatus for practicing the invention. When implemented on a general-purpose microprocessor, the computer program code logic segments configure the microprocessor to create specific logic circuits.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1.-8. (canceled)

9. A system for lifecycle milestone suggestion, the system comprising:
a computer processor configured to perform a method comprising:
identifying a resource related to a user;
determining a start date for the resource;
determining an end state for the resource;
providing a suggestion for at least one piece of web content based on a current milestone for the resource; and
updating the current milestone and providing suggestions based on the updated current milestone over an entire lifecycle of the resource.

10. The system of claim 9, wherein the start date is determined based on a resource classification and information related to the resource.

11. The system of claim 10, wherein the start date is determined based on one or more of:
a date the resource was purchased;
entries on a social network;
data obtained from public registries;
data discovered on an Internet; and
querying the user for the start date;

12. The system of claim 9, wherein the end state is one or more of:
an end date;
a transition event; and
a transformation event.

13. The system of claim 9, wherein the resource, the start date, the end state, and the current milestone are stored in a registry.

14. The system of claim 13, further comprising monitoring the resource for the entire lifecycle of the resource and updating the registry with a new current milestone based on the monitoring.

15. The system of claim 14, wherein in the updating of the registry is based on determining that the current milestone has been met.

16. The system of claim 9, further comprising determining that the end state has been reached and performing one or more of:
preventing further updates to the current milestone;
triggering one or more cleanup actions; and
converting the resource to a new resource.

17-24. (canceled)
